(19) United States
(12) Patent Application Publication
(10) Pub. No.: US 2011/0236540 A1
(43) Pub. Date: Sep. 29, 2011

(54) Ovenable cook-in film with reduced protein adhesion

(75) Inventors: Joseph E. Owensby, Spartanburg, SC (US); Amy Hunter, Greenville, SC (US); Frank M. Hofmeister, Simpsonville, SC (US); Herve M. Brebion, Simpsonville, SC (US)

(73) Assignee: Cryovac, Inc.

(21) Appl. No.: 12/661,805

(22) Filed: Mar. 24, 2010

(51) Int. Cl. B65D 85/00; B65B 25/00; C09K 3/00; C09K 3/10

(52) U.S. Cl. 426/106; 426/392; 252/182.32; 252/182.33

(57) ABSTRACT

The presently disclosed subject matter relates generally to packaging films that exhibit favorable sealing characteristics and reduced adhesion to meat at high temperatures. The presently disclosed subject matter also relates to packages constructed from such films and methods of using the films in high temperature applications.

### FIELD OF THE INVENTION

The presently disclosed subject matter relates generally to packaging films that exhibit favorable sealing characteristics and reduced adhesion to protein at high temperatures. The presently disclosed subject matter also relates to packages constructed from such films and methods of using the films in high temperature applications.

### BACKGROUND

The food packaging industry employs bags, pouches, and the like constructed from packaging films that can be used in cook-in applications, i.e., uses in which a food product is packaged and cooked inside a film. Thus, the term “cook-in” or “retortable” can refer to packaging materials structurally capable of withstanding exposure to cook-in time-temperature conditions while surrounding a food product. In some embodiments, cook-in time-temperature conditions can refer to cooking in a conventional oven and/or direct contact heating (for example, using a double-sided grill) at 350° F. to 400° F. for 3 hours or less. Cook-in packaging materials also maintain seal integrity, i.e., any heat seals maintain their integrity during cook-in.

The cook-in concept is particularly beneficial because it avoids the need for the consumer to handle raw meat, which consumers can find disagreeable. Moreover, the handling of raw meat is a growing concern from a food-safety perspective, and a pre-packaged cook-in food product reduces the risk of contamination. Cook-in packages also increase consumer convenience since cooking instructions can be provided in association with the package. In addition, the pre-packaging of food products can be used as a mechanism of portion control, which is becoming desirable in an increasingly health-conscious marketplace.

However, prior art films used in cook-in applications tend to stick or adhere to proteins in the packaged food products. Particularly, prior art films encounter problems with too much adhesion to the food product during cooking. As the film is removed, it pulls off a portion of the food product, resulting in damage and decreased palatability.

To this end, a packaging film suitable for cook-in applications that exhibits reduced adhesion of the film to the packaged product during and after cooking is desirable.

### SUMMARY

In some embodiments, the presently disclosed subject matter is directed to a retortable film comprising a sealant layer comprising between about 10% and 50% of at least one inorganic material, based on the total weight of the layer. In some embodiments, the amount of inorganic material is effective to substantially preclude adherence of the sealant layer to a protein-containing product in contact with the sealant layer in conditions of from about 200° F. to about 450° F. for about 10 minutes to about 180 minutes.

In some embodiments, the presently disclosed subject matter is directed to an article comprising a package defining an inside, and a protein-containing product positioned inside the package. In some embodiments, the package comprises a retortable film comprising a sealant layer comprising between about 10% and about 50% of at least one inorganic material, based on the total weight of the layer. In some embodiments, the amount of inorganic material is effective to substantially preclude adherence of the sealant layer to the protein-containing product in contact with the sealant layer in conditions of from about 200° F. to about 450° F. for about 10 minutes to about 180 minutes.

In some embodiments, the presently disclosed subject matter is directed to a method of preparing a retortable article, the method comprising preparing a protein-containing product. The method further comprises packaging the protein-containing product in a retortable package constructed from a film comprising a sealant layer comprising between about 10% and 50% of at least one inorganic material, based on the total weight of the layer. Further, the method comprises sealing the package closed so that an article is made, with the protein-containing product being surrounded by the film. In addition, the method comprises retorting the food product by subjecting the article to a temperature of from about 200° F. to about 450° F. for a period of from about 10 minutes to about 180 minutes.

### BRIEF DESCRIPTION OF THE DRAWINGS

FIG. 1 is a cross-sectional view of a monolayer film in accordance with some embodiments of the presently disclosed subject matter.

FIG. 2 is a cross-sectional view of a 4-layer film in accordance with some embodiments of the presently disclosed subject matter.

FIG. 3a is a top plan view of one embodiment of an article formed from a film of the presently disclosed subject matter.

FIG. 3b is a cross-sectional view of the article of FIG. 3a, taken along line 3b-3b.

### DETAILED DESCRIPTION

### I. General Considerations

The presently disclosed subject matter relates generally to films useful for packaging a wide variety of products, including (but not limited to) protein-containing food products, such as meat. More specifically, the presently disclosed subject matter relates to packaging films that are suitable for constructing packages that can be used for high temperature cook-in applications. To this end, in some embodiments, the disclosed packages can withstand temperatures greater than the boiling point of water, i.e., 212° F.; in some embodiments, greater than 300° F.; and in some embodiments, greater than 350° F. The disclosed package can be placed directly into a high temperature environment, such as into a conventional oven or on a double-sided grill apparatus to cook the product contained within the film. In addition, the disclosed films have excellent heat-sealing properties and heat-seal integrity under cook-in conditions.

The disclosed film comprises at least one inorganic material incorporated into the sealant layer. In some embodiments, the inorganic material can be about 10% to about 50%; in some embodiments, between about 12% and 40%; and in some embodiments, between about 10% and 30% of the total weight of the sealant layer. As a result of the inorganic filler incorporated into the film, a reduction in the adherence of the film to the cooked product (which can be, for example, a protein-containing food) is achieved. In some embodiments, adherence of the film to the cooked product is eliminated.

### II. Definitions

While the following terms are believed to be understood by one of ordinary skill in the art, the following definitions are set forth to facilitate explanation of the presently disclosed subject matter.

Unless defined otherwise, all technical and scientific terms used herein have the same meaning as commonly understood by one of ordinary skill in the art to which the presently disclosed subject matter pertains. Although any methods, devices, and materials similar or equivalent to those described herein can be used in the practice or testing of the presently disclosed subject matter, representative methods, device, and materials are now described.

Following long-standing patent law convention, the terms “a”, “an”, and “the” refers to “one or more” when used in the subject specification, including the claims. Thus, for example, reference to “a film” (e.g., “a packaging film”) includes a plurality of such films, and so forth.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, temperature, concentration, or percentage can encompass variations of, in some embodiments ±20%, in some embodiments ±10%, in some embodiments ±5%, in some embodiments ±1%, in some embodiments ±0.5%, and in some embodiments to ±0.1%, from the specified amount, as such variations are appropriate in the disclosed package and methods.

As used herein, the phrase “abuse layer” refers to an outer film layer and/or an inner film layer, so long as the film layer serves to resist abrasion, puncture, and other potential causes of reduction of package integrity, as well as potential causes of reduction of package appearance quality. Abuse layers can comprise any polymer so long as the polymer contributes to achieving an integrity goal and/or an appearance goal. In some embodiments, abuse layers comprise polymer having a modulus of at least 10⁷ Pascals, at room temperature. In some embodiments, the abuse layer comprises at least one member selected from the group consisting of polyamide, ethylene/propylene copolymer; more preferably, nylon 6, nylon 6/6, amorphous nylon, and ethylene/propylene copolymer.

As used herein, the term “adhesive” refers to polymeric adhesive. In some embodiments, the polymeric adhesive can be an olefin polymer or copolymer with an anhydride functionality grafted thereon and/or copolymerized therewith and/or blended therewith. However, any of a variety of commonly used adhesives can be used.

As used herein, the term “article” refers to a package containing an inside portion, and a protein-containing product (such as a cut of meat) positioned within the inside of the package.

As used herein, the term “barrier” and/or the phrase “barrier layer”, as applied to films and/or layers of the disclosed package, are used with reference to the ability of a film or layer to serve as a barrier to one or more gases. In the packaging art, barrier layers can include, but are not limited to, ethylene/vinyl alcohol copolymer, polyvinylidene chloride, polyalkylene carbonate, polyamide, polyethylene naphthalate, polyester, polyacrylonitrile, and combinations thereof, as known to those of skill in the art.

As used herein, the phrase “bulk layer” refers to any layer of a film that is present for the purpose of increasing the abuse-resistance, toughness, modulus, etc., of a multilayer film. Bulk layers generally comprise polymers that are inexpensive relative to other polymers in the film that provide some specific purpose unrelated to abuse-resistance, modulus, etc. Preferably, bulk layers comprise polyolefin; more preferably, at least one member selected from the group consisting of ethylene/alpha-olefin copolymer, ethylene/alpha-olefin copolymer plastomer, low density polyethylene, and linear low density polyethylene.

As used herein, the terms “comprises,” “comprising,” “includes,” “including,” or any other variation thereof are intended to cover a non-exclusive inclusion. For example, a process, method, article, or apparatus that comprises a list of elements is not necessarily limited to only those elements but can include other elements not expressly listed or inherent to such process, method, article, or apparatus.

As used herein, the term “cook-in” refers to the process of cooking a product packaged in a material capable of withstanding exposure to cooking conditions while containing the food product. For example, in some embodiments, cook-in conditions can include direct contact heating (i.e., between heated cooking plates, such as a George Foreman Grill) at temperatures from 300-400° F. for up to 2 hours. Alternatively, in some embodiments, the term “cook-in” can include cooking in a conventional oven, a convection oven, and/or on a Panini grill. Cook-in packaged foods are essentially pre-packaged foods that can be directly transferred to the consumer in this form. Cook-in packaging materials maintain seal integrity and in the case of multilayer films can be delamination resistant. In some embodiments, cook-in films are heat shrinkable under cook-in conditions to form a tightly fitting package.

As used herein, the term “core layer” refers to the central layer or layers of a multilayered film.

The term “directly adjacent” as used herein refers to adjacent layers that are in contact with another layer without any tie layer, adhesive, or other layer therebetween.

As used herein, the term “film” can be used in a generic sense to include plastic web, regardless of whether it is film or sheet.

The terms “first layer”, “second layer”, and the like as used herein are generally indicative of the manner in which a multilayer film structure is built up. That is, in general, the first layer can be present without any of the additional layers described, or the first and second layers can be present without any of the additional layers described, etc.

As used herein, the phrase “food-contact layer” refers to a layer of a film that is in direct contact with the food-containing product packaged in the film. The food-contact layer is an outer layer to be in direct contact with the food product. The food-contact layer is an inside layer in the sense that in the packaged food product, the food-contact layer is the innermost film layer in direct contact with the food.

As used herein, the terms “inner layer” and “internal layer” refer to any layer of a multilayer film having both of its principal surfaces directly adhered to another layer of the film.

As used herein, the term “lamination”, the term “laminate”, and the phrase “laminated film”, refer to the process and resulting product made by bonding together two or more layers of film or other materials. Lamination can be accomplished by joining layers with adhesives, joining with heat and pressure, and/or spread coating and extrusion coating. The term “laminate” is also inclusive of coextruded multilayer films comprising one or more tie layers.

The term “multilayer film” as used herein refers to a thermoplastic material, generally in sheet or web form, having one or more layers formed from polymeric or other materials that are bonded together by any conventional or suitable method, including one or more of the following: coextrusion, extrusion coating, lamination, vapor deposition coating, solvent coating, emulsion coating, and/or suspension coating.

The terms “nylon” or “polyamide” as used herein refer to polymers having amide linkages along the molecular chain. Particularly, such terms encompass both polymers comprising repeating units derived from monomers (such as caprolactam) that polymerize to form a polyamide, as well as polymers of diamines and diacids, and copolymers of two or more amide monomers (including polyamide terpolymers, sometimes referred to in the art as “copolyamides”). The terms “nylon” and “polyamide” also include (but are not limited to) those aliphatic polyamides or copolyamides commonly referred to as nylon 6, nylon 66, nylon 69, nylon 610, nylon 612, nylon 4/6 nylon 6/66, nylon 6/69, nylon 6/610, nylon 66/610, nylon 6/12, nylon 6/12/66, nylon 6/66/610, nylon 6/12/66, nylon 69/66/61, nylon 10/10, nylon 11, nylon 12, nylon 6/12, modifications thereof and blends thereof. The terms “nylon” and “polyamide” also include crystalline, partially crystalline, amorphous, aromatic, and partially aromatic polyamides. Examples of partially crystalline aromatic polyamides include meta-xylylene adipamide (MXD6), copolymers such as MXD6/MXDI, 66/MXD10, and the like. Examples of amorphous polyamides nonexclusively include poly(hexamethylene isophthalamide-co-terephthalamide) (PA-6I/6T), poly(hexamethylene isophthalamide) (PA-6I), and other polyamides abbreviated as PA-MXDI, PA-6/MXDT/I, PA-6,6/6I and the like. Amorphous polyamides can also include polyamides that are prepared from the following diamines: hexamethylenediamine, 2-methylpentamethylenediamine, 2,2,4-trimethylhexamethylenediamine, 2,4,4-trimethylhexamethylenediamine, bis(4-aminocyclohexyl)methane, 2,2-bis(4-aminocyclohexyl)isopropylidine, 1,4-diaminocyclohexane, 1,3-diaminocyclohexane, meta-xylylenediamine, 1,5-diaminopentane, 1,4-diaminobutane, 1,3-diaminopropane, 2-ethyldiaminobutane, 1,4-diaminomethylcyclohexane, p-xylylenediamine, m-phenylenediamine, p-phenylenediamine, and alkyl substituted m-phenylenediamine and p-phenylenediamine. Further, amorphous polyamides can also refer to those prepared from the following dicarboxylic acids: isophthalic acid, terephthalic acid, alkyl substituted iso- and ter-ephthalic acid, adipic acid, sebacic acid, butane dicarboxylic acid, and the like. The diamines and diacids mentioned above can be combined as desired, provided the resulting polyamide is amorphous. Further, the nylons and polyamides suitable for use with the presently disclosed subject matter are approved for use in producing articles intended for use in processing, handling, and packaging food, including homopolymers, copolymers and mixtures of the nylon materials described in 21 C.F.R. 177.1500 et al., incorporated by reference herein in its entirety.

As used herein, the term “outer layer” refers to any film layer having less than two of its principal surfaces directly adhered to another layer of the film. The phrase is inclusive of monolayer and multilayer films. In multilayer films, there are two outer layers, each of which has a principal surface adhered to only one other layer of the multilayer film. In monolayer films, there is only one layer, which, of course, is an outer layer in that neither of its two principal surfaces is adhered to another layer of the film.

As used herein, the term “package” refers to an object of manufacture that can be in the form of a web (e.g., monolayer or multilayer films, monolayer or multilayer sheets), bag, shrink bag, pouch, casing, tray, lidded tray, overwrapped tray, shrink package, vacuum skin package, flow wrap package, thermoformed package, packaging insert, or combinations thereof. It will be appreciated by those skilled in the art that such packages can include flexible, rigid, or semi-rigid materials and can be heat shrinkable or non-heat shrinkable, and oriented or non-oriented.

As used herein, the term “polymer” refers to the product of a polymerization reaction, and can be inclusive of homopolymers, copolymers, terpolymers, etc. In some embodiments, the layers of a film can consist essentially of a single polymer, or can have still additional polymers together therewith, i.e., blended therewith.

As used herein, the terms “product” or “packaged product” can include protein-containing food products (e.g., ground or processed meat products including fresh red meat, poultry, pork, sausage, lamb, goat, horse, fish, and the like). The food product can contain at least about each of the following weight % of proteinaceous food: 10, 15, 20, 25, 30, 35, 40, 45, 50, 55, 60, 65, 70, 75, 80, 85, 90, 95, 98, and 100.

As used herein, the term “retortable” refers to a film that can be formed into a pouch, filled with a product, sealed, and subjected to conditions of high temperature (between about 200° F. and about 450° F.), for a period of time of between 10 minutes and 3 hours to cook and/or heat the product. Thus, in some embodiments, the retortable package can be subjected to temperatures of about 200° F., 225° F., 250° F., 275° F., 300° F., 325° F., 350° F., 375° F., 400° F., 425° F., or 450° F. (and all temperatures in between, such as 201° F., 202° F., 203° F., etc.) for a period of time of about 10, 20, 30, 40, 50, 60, 70, 80, 90, 100, 110, 120, 130, 140, 150, 160, 170, or 180 minutes (and all times in between, such as 11 minutes, 12 minutes, 13 minutes, etc.). Thus, the disclosed package can be subjected to temperatures of about 200-450° F. for 10-180 minutes. In some embodiments, the conditions can include cooking the packaged product in a microwave, submersion in boiling or hot water, pop-up toaster, toaster oven, wok, broiler, conventional oven, convection oven, conventional grill, direct contact with a double-sided grill, and the like.

As used herein, the term “seal” refers to any bond of a first region of an outer film surface to a second region of an outer film surface, including heat or any type of adhesive material, thermal or otherwise. In some embodiments, the seal is formed by heating the regions to at least their respective seal initiation temperatures. The sealing can be performed by any one or more of a wide variety of means, such as, but not limited to, using a heat seal technique (e.g., melt-bead sealing, thermal sealing, impulse sealing, dielectric sealing, radio frequency sealing, ultrasonic sealing, hot air, hot wire, infrared radiation, and the like).

As used herein, the phrases “seal layer”, “sealing layer”, “heat seal layer”, and “sealant layer” refers to an outer layer or layers involved in the sealing of a film to itself, another layer of the same or another film, and/or another article that is not a film. In general, sealant layers employed in the packaging art have included the genus of thermoplastic polymers, including (but not limited to) thermoplastic polyolefin, polyamide, polyester, polyvinyl chloride, homogeneous ethylene/alpha-olefin copolymer, polypropylene, polypropylene copolymer, ethylene/vinyl acetate copolymer, and ionomer. In some embodiments, the sealant layer can be termed the “food contact layer.”

As used herein, the term “tie layer” refers to any internal film layer having the primary purpose of adhering two layers to one another. In some embodiments, tie layers can comprise any nonpolar polymer having a polar group grafted thereon, so that the polymer is capable of covalent bonding to polar polymers, such as polyamide and ethylene/vinyl alcohol copolymer. In some embodiments, tie layers can comprise at least one member of the group including, but not limited to, modified polyolefin, modified ethylene/vinyl acetate copolymer, anhydride grafted ethylene/methyl acrylate copolymer, homogeneous ethylene/alpha-olefin copolymer, and combinations thereof. In some embodiments, tie layers can comprise at least one member selected from the group including, but not limited to, anhydride modified grafted linear low density polyethylene, anhydride grafted low density polyethylene, homogeneous ethylene/alpha-olefin copolymer, anhydride grafted ethylene/methyl acrylate copolymer, and/or anhydride grafted ethylene/vinyl acetate copolymer.

All compositional percentages used herein are presented on a “by weight” basis unless designated otherwise.

### III. The Disclosed Film

III.A. Generally

The presently disclosed film can be multilayer or monolayer. Typically, however, the films employed will have two or more layers to incorporate a variety of properties, such as sealability, gas impermeability, and toughness into a single film. Thus, in some embodiments, the disclosed film comprises a total of from about 1 to about 20 layers; in some embodiments, from about 2 to about 12 layers; and in some embodiments, from about 3 to about 9 layers. Accordingly, the disclosed film can comprise 1, 2, 3, 4, 5, 6, 7, 8, 9, 10, 11, 12, 13, 14, 15, 16, 17, 18, 19, or 20 layers. One of ordinary skill in the art would also recognize that the disclosed film can comprise more than 20 layers, such as in embodiments wherein the film components comprise microlayering technology.

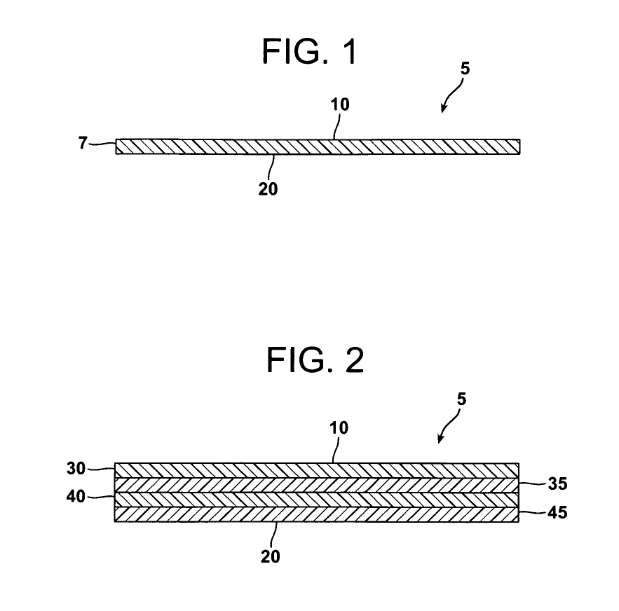

Accordingly, as illustrated in FIG. 1, in some embodiments, film 5 can be a monolayer film comprising core layer 7. Core layer 7 comprises interior (i.e., food-side) surface 10 that is proximate to or contacting a packaged product. Core layer 7 also comprises exterior surface 20 positioned opposite to interior surface 10. Thus, in some embodiments, film 5 can by itself be considered a food contact or sealant layer. As is readily understood to those having ordinary skill in the art of film manufacture, a greater number of layers can be included, depending on the specific attributes that are desired in such a film to suit the intended end-use application.

Thus, in some embodiments, film 5 can be multilayered (i.e., the film comprises at least two layers). For example, FIG. 2 illustrates a cross-sectional view of a multilayered film comprising 4 layers. In the embodiment depicted in FIG. 2, film 5 comprises interior surface 10 that is proximate to or contacting a packaged product and exterior surface 20 positioned opposite to interior surface 10. In addition, the film of FIG. 2 comprises sealant layer 30, first inner layer 35, second inner layer 40, and external layer 45. An “inner layer” is a layer that has both of its surfaces directly adhered to other layers of the multilayer film. It is noted that in some embodiments FIG. 2 is not drawn to scale and layers 30, 35, 40, and 45 can be of varying thicknesses compared to one another.

Film 5 can have any total thickness desired, so long as the film provides the desired properties for the particular packaging operation in which the film is used, e.g., optics, modulus, seal strength, and the like. Final web thicknesses can vary, depending on processing, end use application, and the like. Typical thicknesses can range from about 0.1 to 20 mils; in some embodiments, about 0.3 to 15 mils; in some embodiments, about 0.5 to 10 mils; in some embodiments, about 1 to 8 mils; in some embodiments, about 1 to 4 mils; and in some embodiments, about 1 to 2 mils. Thus, in some embodiments, film 5 can have a thickness of about 10 mils or less; in some embodiments, a thickness of about 5 mils or less.

In some embodiments, film 5 can be transparent (at least in the non-printed regions) such that the packaged product is visible through the film. The term “transparent” as used herein can refer to the ability of a material to transmit incident light with negligible scattering and little absorption, enabling objects (e.g., packaged food or print) to be seen clearly through the material under typical unaided viewing conditions (i.e., the expected use conditions of the material). The transparency of the film can be at least about any of the following values: 20%, 25%, 30%, 40%, 50%, 65%, 70%, 75%, 80%, 85%, and 95%, as measured in accordance with ASTM D1746.

In some embodiments, film 5 can comprise printed product information such as (but not limited to) product size, type, name of manufacturer, cooking instructions, and the like. Such printing methods are well known to those of ordinary skill in the packaging art.

III.B. Sealant Layer 30

The sealant layer of film 5 comprises at least one inorganic material. In some embodiments, the sealant layer can comprise a blend of nylon and inorganic material. As used herein, the term “inorganic material” includes (but is not limited to) one or more of the following: calcium carbonate (CaCO₃), calcium sulfate (CaSO₄, which can also be referred to as “gypsum”), a silicate, a silica (SiO₂), titanium dioxide (TiO₂), potassium iodide, calcium phosphate, microspheres (particles ranging in size from 1 to about 225 microns in size, which can include, but are not limited to, 3M™ Zeeospheres™).

III.B.i. Calcium Carbonate

Calcium carbonate can include natural calcium carbonate, issued from ground chalk, limestone, or marble. In addition, the term “calcium carbonate” can include synthetic calcium carbonate obtained by precipitation. Further, dolomite (CaMg(CO₃)₂) issued from ground dolomite can also be included as a calcium carbonate.

III.B.ii. Silicates

Silicates suitable for use in the disclosed film can include glass spheres and silica spheres (i.e., ceospheres). Suitable silicates can also include tectosilicates (or “framework silicates”) that have a 3-dimensional framework of silicate tetrahedral with SiO₂. The feldspar group (anhydrous alkali/aluminum silicate) is an example of a tectosilicate. In addition, calcium silicate and aluminum silicates can also be included. Further, diatomaceous earth (also referred to as “natural silica”) or synthetic (also referred to as “manufactured”) silicon dioxide can be used as an inorganic filler.

Silicates can also include single chain inosilicates that include (but are not limited to) the pyroxenoid group (which include wollastonite (CaSiO₃), rhodonite (MnSiO₃), and pectolite (NaCa₂(Si₃O₈)(OH)).

Further, silicates can include phyllosilicates that include (but are not limited to) the serpentine group (also known under “asbestos”) which includes, but is not limited to, antigorite (Mg₃Si₂O₅(OH)₄), chrysotile, (Mg₃Si₂O₅(OH)₄), and lizardite (Mg₃Si₂O₅(OH)₄).

Phyllosilicates can also include the clay mineral group, which includes halloysite (Al2Si2O5(OH)4) and kaolinite Al₂Si₂O₅(OH)₄, Illite (K,H₃O)(Al, Mg, Fe)₂(Si,Al)₄O₁₀-[(OH)₂(H₂O)], and montmorillonite (Na,Ca)_{0.33}(Al,Mg)₂(Si4O₁₀(OH)₂.nH₂O, which is a hydrated sodium calcium aluminum magnesium silicate hydroxide that is intermixed with chlorite, muscovite, illite, cooeite, and kaolinite. Montmorillonite can also include, for example, nano-sized particles. Clays can also include vermiculite (Mg,Fe,Al)₃(Al,Si)4O₁₀(OH)₂.4H₂O, talc (hydrated magnesium silicate, 3MgO⁴SiO₂H₂O), palygorskite (Mg,Al)₂Si₄O₁₀(OH).4H₂O and pyrophyllite (Al₂Si₄O₁₀(OH)₂). Additional clays suitable for use in the disclosed film include (but are not limited to) bentonite, attapulgite, beidellite, kaolin, saponite, vermiculite, fibrous clays, hectorite, and laponite.

Phyllosilicates can also include the mica group that includes (but is not limited to) muscovite (K₂Al₄(Al₂Si₆O₂O(OH)₄), phlogopite (K₂(MgFe²⁺)₆(Al₂Si₆O₂₀)(OH,F)₄, biotite (K(Mg,Fe)₃(AlSi₃O₁₀)(OH)₂, lepidolite (K(Li,Al)₂₋₃(AlSi₃O₁₀)(OH)₂, margarite (CaAl₂(Al₂Si₂O₁₀)(OH)₂, and glauconite (K,Na)(Al,Mg,Fe)₂(Si,Al)₄O₁₀(OH)₂.

The phyllosilicates can also include the chlorite group, which includes (but is not limited to) chlorite—(Mg,Fe)₃(Si,Al)₄O₁₀(OH)₂.(Mg,Fe)₃(OH)₆.

III.B.iii. Silica

The silica group includes natural silicas, such as (but not limited to) quartz, sand, quartzite, and diatomaceous earth. In addition, the silica group includes synthetic silicas.

III.B.iv. Titanium Dioxide

Titanium dioxide occurs in nature as well-known minerals, such as rutile, anatase, and brookite.

III.B.v. Generally

The amount of inorganic material present in sealant layer 30 imparts a cooked protein/non-adherence attribute to film 5 such that the layer (and thus the film) exhibits reduced or eliminated adherence to the packaged protein-containing food product. Thus, the amount of inorganic material in the sealant layer is desirably an amount effective to reduce the cooked protein adherence attributes of said layer of film 5. As would be apparent to one of ordinary skill in the art, effective amounts of inorganic material present in the sealant layer can vary with the composition and concentration of the selected food product (e.g., protein, fat, water, starch contents). To this end, some embodiments of the sealant layer can include at least about 10% inorganic material, based on the total weight of the sealant layer.

The inorganic components of the sealant layer can be mixed together in a conventional manner. For example, in some embodiments, the inorganic materials can be mixed with the other polymer components of the layer by tumble or dry blending, or by compounding in an extruder, followed by cooling. Masterbatching technology can also be employed.

In some embodiments, the sealant layer comprises a blend of nylon and inorganic material. Particularly, in some embodiments the composition of said film layer comprises a blend of between about 50% and 90% nylon and between about 10% and 50% inorganic material, based on the total weight of the layer. All percentages given herein are by weight of the appropriate layer or blend. Thus, in some embodiments, the sealant layer can comprise about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 percent inorganic material, based upon the total weight of the layer. Likewise, in some embodiments, the sealant layer can comprise about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 percent nylon, based upon the total weight of the sealant layer.

III.C. Additional Layers

In some embodiments, film 5 can comprise a barrier layer to serve as a barrier to one or more gases. Such barrier layers can include, but are not limited to, ethylene/vinyl alcohol copolymer, polyvinylidene chloride, polyalkylene carbonate, polyamide, polyethylene naphthalate, polyester, polyacrylonitrile, and combinations thereof, as known to those of skill in the art.

In some embodiments, film 5 can comprise an abuse layer. The abuse layer can be any film layer, so long as the film layer serves to resist abrasion, puncture, or other potential causes of reduction of package integrity or package appearance quality.

In some embodiments, the presently disclosed film can comprise a bulk layer that functions to increase the abuse resistance, toughness, and/or modulus of the film.

In some embodiments, the presently disclosed film can comprise one or more tie layers adapted for improving the adherence of one layer of said film to another layer.

The disclosed film and/or the sealant layer can include other additives commonly used with cook-in film compositions. For example, in some embodiments, the food-side external layer can include amounts of plasticizer effective to enhance the processibility of the film to a desired amount, for example from 2 to 12 weight percent, and from 4 to 10 weight percent; but can also include less than each of the following amounts of plasticizer: 20%, 15%, 12%, 10%, 8%, 6%, and 4%, each based on the weight of the sealant layer. In some embodiments, the amount of plasticizer is only that amount needed to provide the desired enhancement of processibility so that the attributes of film 5 are not further deteriorated.

Other useful additives that can be included within film 5 or sealant layer 30 include effective amounts of thermal stabilizer (e.g., a hydrogen chloride scavenger such as epoxidized soybean oil), lubricating processing aid (e.g., one or more acrylates), processing aids, slip agents, antiblock agents, and pigments. Preferably, the amount of additives present in the film are minimized in order that the film properties are not deteriorated.

### IV. Methods of Making Film 5

Film 5 can be constructed using any suitable process known to those of ordinary skill in the art, including (but not limited to) coextrusion, lamination, extrusion coating, and combinations thereof. See, for example, U.S. Pat. Nos. 6,769,227 to Mumpower; 3,741,253 to Brax et al.; 4,278,738 to Brax et al.; 4,284,458 to Schirmer; and 4,551,380 to Schoenberg, each of which is hereby incorporated by reference in its entirety.

For example, the disclosed film can be prepared by extrusion or coextrusion utilizing, for example, a tubular trapped bubble film process or a flat film (i.e., cast film or slit die) process. The film can also be prepared by extrusion coating. Alternatively, multilayer embodiments of the present film can be prepared by adhesively laminating or extrusion laminating the various layers. A combination of these processes can also be employed. These processes are known to those of skill in the art.

### V. Use of the Disclosed Film

Film 5 can be formed into a package for containing and cooking a food product (i.e., film 5 is retortable). For example, suitable package configurations can include (but are not limited to) end-seal bags, side-seal bags, L-seal bags, pouches, and seamed casings (e.g., back-seamed tubes by forming an overlap or fin-type seal). Such configurations are known to those of skill in the art. Alternatively or in addition, film 5 can be tightly wrapped around a product by vacuum wrapping (using conventional vacuum wrapping equipment), shrink wrapping (e.g., by orienting the film during the film manufacturing process and thereafter heating the film, causing it to shrink tightly around the food product), and/or similar type conventional or non-conventional wrapping methods.

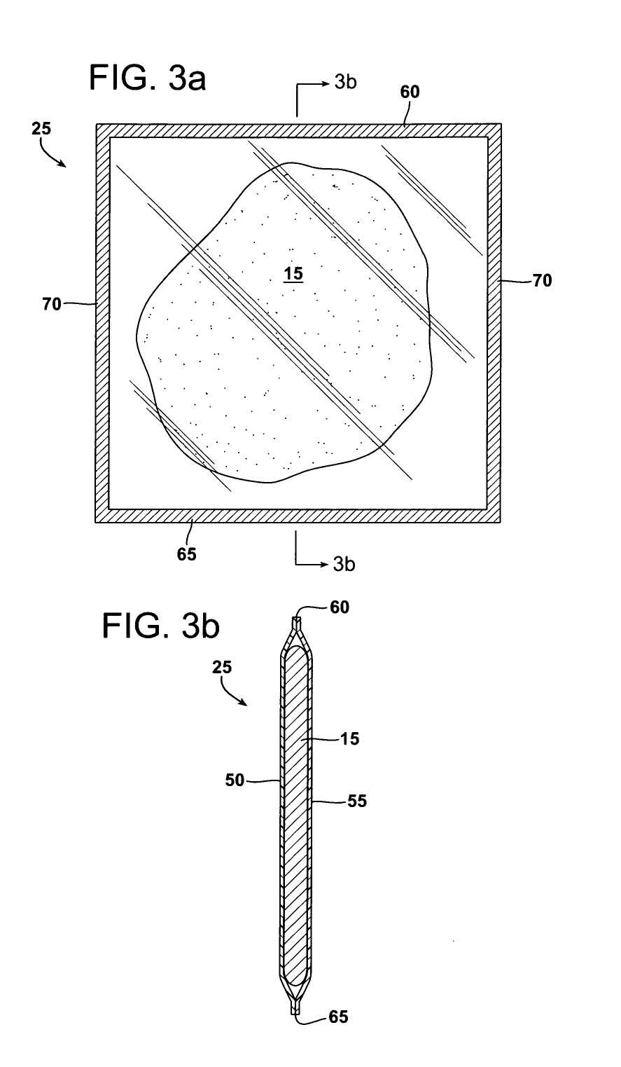

Particularly, FIGS. 3a and 3b depict one embodiment of a package that can be used in accordance with the presently disclosed subject matter. Package 25 can be constructed from front film 50 and rear film 55. One of ordinary skill in the art can appreciate that in lieu of the front and rear sheets, a single sheet of film can be folded over and sealed. Front film 50 and rear film 55 are sealed together around their edges to form top seal 60, bottom seal 65 and side seals 70. Although depicted as rectangular in shape in the Figures, package 25 can be constructed in any desired size and shape.

Seals 60, 65, and 70 can be constructed using any of a number of means well known in the art, including (but not limited to) the application of heat, pressure, and/or adhesives. In some embodiments, film 5 is capable of forming heat seals to itself that will not fail or delaminate after exposure to cooking conditions, for example, temperatures of around 350° F. to 400° F. for up to about three hours.

Package 25 can be filled with product 15 using any of a wide variety of means, including vertical form-fill-seal or horizontal form-fill-seal processes known to those of ordinary skill in the art. See, for example U.S. Pat. Nos. 5,228,531; 5,360,648; 5,364,486; 5,721,025; 5,879,768; 5,942,579; and 6,117,465, the entire disclosures of which are hereby incorporated by reference. As set forth herein above, once package 25 is filled with product 15 and sealed, it can be referred to as “an article.”

The product enclosed within the package can then be cooked or retorted for an effective amount of time and at an effective temperature. To this end, package 25 (and the associated article) can be subjected to any of a wide variety of cooking appliances known in the art including (but not limited to) microwave, submersion in boiling or hot water, pop-up toaster, toaster oven, wok, broiler, conventional oven, convection oven, conventional grill, double-sided grill, and the like. For example, in some embodiments, the article can be cooked and/or heated directly on an indoor electric grill containing a double-sided cooking surface with a series of parallel ridges. One example of this type of appliance is the George Foreman Grill® (available from Applica Consumer Products, Inc., Miramar, Fla., United States of America). In this type of grill, two grill elements cook/grill the food on the top and the bottom sides simultaneously.

During the cooking process, the article is typically exposed to sufficient temperatures for a sufficient time to heat and/or cook product 15 as desired. For example, in some embodiments, the article can be exposed to temperatures ranging from 200° F. to 450° F.; in some embodiments, from 300° F. to 400° F.; and in some embodiments, from 350° F. to 400° F. In some embodiments, exposure to elevated temperatures can shrink the package tightly about product 15 as a result of heat shrinkage of film 5. Furthermore, during the cooking process, the article can be cooked or retorted for up to 12 hours. For example, in some embodiments, product 15 can be cooked for 10 minutes to 1 hour.

As disclosed herein in more detail, in some embodiments, if the amount of inorganic material blended into the sealant layer of film 5 is at least about 10%; in some embodiments, at least about 12%; and in some embodiments, at least about 15% of the total weight of the layer, the cooked food product will be precluded from adhering to the film. The film can be considered “non-adhering” or “not adhered” to a particular product (e.g., a protein-containing food) if the film does not appear (after unaided visual inspection of the film from a 12-inch distance) to have any amount of the cooked food product adhering or remaining attached to the film after the film has been stripped from the packaged, cooked food product. Alternatively, in some embodiments, film 5 can be considered “substantially non-adhering” such that less than 15% (which can include 0.5%, 1%, 2%, 3%, 4%, 5%, 6%, 7%, 8%, 9%, 10%, 11%, 12%, 13%, 14%, or 15%) of the total weight of the cooked food product remains attached to the film after the film has been stripped from the packaged, cooked food product. Thus, the presently disclosed subject matter includes a film comprising inorganic material in the sealant layer, wherein the amount of inorganic material is effective to substantially preclude adherence of the sealant layer to the food product in contact with the sealant during retort conditions (i.e., 15% or less of the total weight of the cooked food product remains attached to the film after the film has been removed from the cooked food product).

The disclosed films have been described in connection with cook-in applications. However, it is to be understood that other applications for the films are also possible (such as, for example, medical applications). Accordingly, the subject disclosure should not be construed as being limited solely to food packages.

### VI. Advantages of the Disclosed Film

Film 5 advantageously reduces or eliminates adherence of the film to packaged food products during or after the cooking. Particularly, the presently disclosed subject matter comprises films in which at least one inorganic material has been blended into the sealant layer of the film. In some embodiments, the amount of inorganic material in the sealant layer is about 10% to about 50% of the total weight of the layer. The inorganic material is believed to effectively reduce or eliminate adhesion to the packaged product and associated product damage.

In addition, the inorganic materials blended into the sealant layer of film 5 are FDA accepted high temperature materials. Accordingly, film 5 maintains FDA approval for high temperature cook-in applications.

Further, film 5 offers a cost-effective means to reduce adhesion of the film to a packaged product. That is, the inorganic materials described herein above are comparatively inexpensive compared to other film materials used in the packaging art.

Despite the blending of inorganic materials into the sealant layer of film 5, the film still can be effectively sealed using conventional sealing hardware and temperatures.

Also, the presently disclosed subject matter includes a reduction in film use. Particularly, prior art solutions to product-film adhesion has been to use an oversized package (i.e., larger than needed) to promote reduced contact with the product during cooking. Thus, the disclosed film solves the adhesion problem without having to oversize the package and thereby waste film.

Further, the presently disclosed subject matter eliminates the need to provide controlled venting of the cook-in package. Specifically, prior art solutions to product-film adhesion have been to use controlled venting of the cook-in package to balloon the film away from the product during cooking. Thus, the disclosed film solves the adhesion problem without requiring controlled venting, thereby simplifying the package design and saving money.

In addition, the presently disclosed package enhances the aesthetics of the packaged product. Particularly, the package provides reduced adhesion to the cooked product, thereby increasing consumer acceptable of the appearance of the cooked product.

### EXAMPLES

The following examples provide illustrative embodiments. In light of the present disclosure and the general level of skill in the art, those of ordinary skill can appreciate that the following examples are intended to be exemplary only and that numerous changes, modifications, and alterations can be employed without departing from the scope of the presently claimed subject matter.

Several film structures in accordance with the presently disclosed subject matter and comparatives are identified herein below.

TABLE 1
Resin Identification

| Material | Trade name Or | |
|---|---|---|
| Code | Designation | Source(s) |
| A | ULTRAMID C33 LN 01 | BASF Corporation |
| | | (Florham Park, New |
| | | Jersey, United States of |
| | | America) |
| B | ULTRAMID B40 LN 01 | BASF Corporation |
| | | (Florham Park, New |
| | | Jersey, United States of |
| | | America) |
| C | Sicopas 448 | BASF Corporation |
| | | (Florham Park, New |
| | | Jersey, United States of |
| | | America) |
| D | NA 189 | Solutia, Inc. (St. Louis, |
| | | Missouri, United States of |
| | | America) |
| E | Vydyne 65A | Solutia, Inc. (St. Louis, |
| | | Missouri, United States of |
| | | America) |
| F | Grilon BM 20 SBG | EMS-Chemie, Inc. |
| | natural | (Sumter, South Carolina, |
| | | United States of America) |
| G | MB50-011 | Dow Chemical Company |
| | | (Midland, Michigan, |
| | | United States of America) |
| H | ULTRAMID C33 01 | BASF Corporation |
| | | (Florham Park, New |
| | | Jersey, United States of |
| | | America) |
| I | PNM14045 | Techmer PM (Clinton, |
| | | Tennessee, United |
| | | States of America) |
| J | CC10000711WE WHITE | PolyOne Corp. (Avon |
| | TIO2 | Lake, Ohio, United States |
| | | of America) |

A is a nylon-6/66.
B is a nylon-6 with specific gravity of 1.12-1.16 and DSC melting point 220° C. (+/−10° C.).
C is an antiblock (silica in nylon-6) with antiblock agent (SiO₂ - ISO 15512) target of 6.0 wt. % and moisture content (ISO 3451-4) < 0.12%.
D is a heat stabilizer with copper (I) iodide concentration of 1.39% and potassium iodide concentration of 9.8% in a nylon 6/66 carrier.
E is a nylon-66 with relative viscosity of 120 (+/−10), DSC melting point 260° C. (+/−3° C.) and density of 1.14.
F is a nylon-66/610 with specific gravity 1.09 and DSC melting point 205° C. (+/−5° C.).
G is a slip agent with density 1.05 g/cc, 47-53 wt % siloxane and low viscosity nylon-6 as carrier resin.
H is a nylon 6/66 with DSC melting point 196° C. (+/−6° C.) and density of 1.13 g/cc.
I is a TiO₂ masterbatch in nylon-6 with density of 1.78 g/cc.
J is a pigment masterbatch based in nylon 6 with 45% TiO₂ (by weight) and density of 135-145 lb/ft³.

TABLE 2
Film Identification

| | | | | | Layer |
|---|---|---|---|---|---|
| | | | | | Thickness |
| Film ID | Layer | Formulation | | Volume % | (mils) |
| Film 1 | 1 | 71% | A | 12.0 | 0.96 |
| | | 20% | B | | |
| | | 8% | C | | |
| | | 1% | D | | |
| | 2 | 55% | E | 25.0 | 2.0 |
| | | 25% | B | | |
| | | 20% | F | | |
| | 3 | 55% | E | 43.0 | 3.44 |
| | | 25% | B | | |
| | | 20% | F | | |
| | 4 | 55% | E | 20.0 | 1.6 |
| | | 24.3% | B | | |
| | | 20% | F | | |
| | | 0.7% | G | | |
| Film 2 | 1 | 54% | H | 12.0 | 0.96 |
| | | 45% | I | | |
| | | 1% | D | | |
| | 2 | 55% | E | 25.0 | 2.0 |
| | | 25% | B | | |
| | | 20% | F | | |
| | 3 | 55% | E | 43.0 | 3.44 |
| | | 25% | B | | |
| | | 20% | F | | |
| | 4 | 55% | E | 20.0 | 1.6 |
| | | 24.3% | B | | |
| | | 20% | F | | |
| | | 0.7% | G | | |
| Film 3 | 1 | 55% | I | 12.0 | 0.96 |
| | | 44% | H | | |
| | | 1% | D | | |
| | 2 | 55% | E | 25.0 | 2.00 |
| | | 25% | B | | |
| | | 20% | F | | |
| | 3 | 55% | E | 43.0 | 3.44 |
| | | 25% | B | | |
| | | 20% | F | | |
| | 4 | 55% | E | 20.0 | 1.6 |
| | | 24.3% | B | | |
| | | 20% | F | | |
| | | 0.7% | G | | |
| Film 4 | 1 | 60% | I | 12.0 | 0.96 |
| | | 39% | H | | |
| | | 1% | D | | |
| | 2 | 55% | E | 25.0 | 2.00 |
| | | 25% | B | | |
| | | 20% | F | | |
| | 3 | 55% | E | 43.0 | 3.44 |
| | | 25% | B | | |
| | | 20% | F | | |
| | 4 | 55% | E | 20.0 | 1.6 |
| | | 24.3% | B | | |
| | | 20% | F | | |
| | | 0.7% | G | | |
| Film 5 | 1 | 69% | H | 100 | 2.0 |
| | | 30% | J | | |
| | | 1% | D | | |
| Film 6 | 1 | 50% | J | 100 | 2.0 |
| | | 49% | H | | |
| | | 1% | D | | |

### Example 1

### Preparation of Multilayer Films 1-4

Multilayer films 1-4, with the compositions and constructions shown in Table 2, were constructed by cast coextrusion.

### Example 2

### Preparation of Packages 1-4

Film 1 of Example 1 was used to form two 6 inch×8 inch pouches, each pouch having three edges heat sealed together using an Impulse Sealer (Model No. AIE-405HIM 16 inch., provided by American International Electric Inc., Whittier, Calif., United States of America) set at about 356° F. for about 7 seconds to seal the edge areas of the first layers of the superimposed sheets together. About 2 ounces of raw frozen tilapia filets was placed into each pouch. The fourth edge of each pouch was then heat sealed using the Impulse Sealer set at about 356° F. for about 7 seconds to form two closed packages (Packages 1a and 1b) enclosing the tilapia.

Packages 1a and 1b were then vented by manually inserting a thumbtack into the top of each package three times in a triangular pattern.

Film 2 of Example 1 was used to form two vented packages (Packages 2a and 2b) using the method set forth for Film 1.

Film 3 of Example 1 was used to form two vented packages (Packages 3a and 3b) using the method set forth for Film 1.

Film 4 of Example 1 was used to form two vented packages (Packages 4a and 4b) using the method set forth for Film 1.

### Example 3

### Cooking of Packages 1-4

Package 1a was placed on a George Foreman Grill (Model No. GRP99B, available from Applica Consumer Products, Inc., Miramar, Fla., United States of America) containing two horizontal heating plates and cooked at about 350° F. for about 6 minutes.

Package 1b was placed on a vertical grill containing two vertical heating plates and cooked at about 350° F. and about 15 psi for about 6 minutes.

Packages 2a and 2b were cooked using the same methods as for Packages 1a and 1b, respectively.

Packages 3a and 3b were cooked using the same methods as for Packages 1a and 1b, respectively.

Packages 4a and 4b were cooked using the same methods as for Packages 1a and 1b, respectively.

### Example 4

### Package Adherence Observations

After cooking as set forth in Example 3, the packages were cut open using a cutting utensil and the amount of cooked meat that adhered to the package film was observed. Particularly, each package was given a score from 1-5, with “1” representing an observation of about 0% film/meat adherence (based on the total weight of the meat), “2” representing an observation of about 1-5% film/meat adherence, “3” representing an observation of about 6-10% film/meat adherence, “4” representing an observation of about 11-15% film/meat adherence, and “5” representing an observation of 16% or more film/meat adherence. The scoring for each package is set forth in Table 3, below.

TABLE 3
Visual Adherence Scores

| Package No. | Score |
|---|---|
| 1a | 3 |
| 1b | 5 |
| 2a | 2 |
| 2b | 4 |
| 3a | 2 |
| 3b | 3 |
| 4a | 2 |
| 4b | 3 |

Packages 1a and 1b were the control packages (no inorganic fillers present in the sealant layer of the film). It was observed that the horizontally cooked package (Package 1a) resulted in mild adherence (“3”), while the vertically cooked package (Package 1b) resulted in a large amount of adherence (“5”).

Packages 2a and 2b contained a sealant layer with 22.5% inorganic filler (TiO₂) by weight. It was observed that the horizontally cooked package (Package 2a) showed minimal adherence (“2”) after cooking, and the vertically cooked package (Package 2b) showed an increased amount of adherence (“4”).

Packages 3a and 3b contained a sealant layer with 27.5% inorganic filler (TiO₂) by weight. It was observed that the horizontally cooked package (Package 3a) showed minimal adherence (“2”) after cooking, and the vertically cooked package (Package 3b) showed mild adherence (“3”).

Packages 4a and 4b contained a sealant layer with 30.5% inorganic filler (TiO₂) by weight. It was observed that the horizontally cooked package (Package 4a) showed minimal adherence after cooking (“2”), and the vertically cooked package (Package 4b) showed mild adherence (“3”).

Packages 2-4 containing the inorganic filler performed better (i.e., less adherence of the cooked meat to the film was observed) compared to control Package 1, which contained no inorganic filler. Specifically, it is believed that Packages 2-4 adhered less because the surface of the fillers released from the protein in the meat. Particularly, the presence of the inorganic fillers on the surface of the film reduced the amount of surface area of nylon that was able to adhere to the meat.

It was observed that the packages prepared on the vertical grill had more adhesion compared to the packaged prepared on the George Foreman Grill (horizontal grill). It is believed that the increased adherence in the vertical grill was a result of the pressure (15 psi) applied to produce grill marks.

### Example 5

### Preparation of Monolayer Films 5 and 6

Monolayer films 5 and 6 were formed with the compositions and constructions shown in Table 2.

### Example 6

### Preparation of Packages 1a-1d

Packages 1a and 1b were prepared as set forth above in Example 2. Packages 1c and 1d were prepared as Packages 1a and 1b, except the interior of the two packages were coated with Pam Cooking Spray (available from ConAgra Foods, Inc., Omaha, Nebr., United States of America) prior to addition of the tilapia.

### Example 7

### Preparation of Packages 5 and 6

Film 5 of Example 5 was used to form four 6 inch×8 inch pouches, each pouch having three edges heat sealed together using an Impulse Sealer under the conditions set forth in Example 2 to seal the edge areas of the first layers of the superimposed sheets together. About 2 ounces of frozen raw tilapia filets were placed into each pouch. Of the 4 packages, the interior of two packages (Packages 5c and 5d) were coated with Pam Cooking Spray (available from ConAgra Foods, Inc., Omaha, Nebr., United States of America) prior to addition of the tilapia. The fourth edge of each pouch was then heat sealed using the Impulse Sealer as set forth in Example 2 to form 4 closed packages (Packages 5a, 5b, 5c, and 5d).

Packages 5a-5d were then vented as set forth in Example 2.

Film 6 of Example 5 was used to form 4 packages (Packages 6a, 6b, 6c, and 6d) using the method set forth for Film 5, above.

### Example 8

### Cooking of Packages 1, 5, and 6

Packages 1a, 1c, 5a, 5c, 6a, and 6c were placed on a George Foreman Grill set to 350° F. and cooked for about 6 minutes.

Packages 1b, 1d, 5b, 5d, 6b, and 6d were placed on a vertical grill containing two vertical heating plates and cooked at about 350° F. for about 6 minutes. The vertical grill was set at 15 psi to achieve grill marks on the meat.

### Example 9

### Package Adherence Observations

After cooking as set forth in Example 7, packages 1a-1d, 5a-5d, and 6a-6d were cut open using a cutting utensil and the amount of cooked meat that adhered to the film of each package was observed. Particularly, each package was given a score from 1-5, as set forth in Example 4.

TABLE 4
Visual Adherence Scores

| Package No. | Score |
|---|---|
| 1a | 5 |
| 1b | 4 |
| 1c | 3.5 |
| 1d | 3.5 |
| 5a | 1.5 |
| 5b | 2 |
| 5c | 1.5 |
| 5d | 1.5 |
| 6a | 4.5 |
| 6b | 4.5 |
| 6c | 2 |
| 6d | 1.5 |

Packages 1a and 1b were the control packages (no inorganic fillers present in the sealant layer of the film and no cooking spray). It was observed that the horizontally cooked package (Package 1a) resulted in major adherence (“5”), while the vertically cooked package (Package 1b) resulted in significant adherence (“4”).

Packages 1c and 1d were the control packages that were coated with the cooking spray. It was observed that both the horizontally and vertically cooked packages (Packages 1c and 1d) exhibited a high level of adherence (“3.5”).

Packages 5a-5d were constructed from monolayer films containing 13.5% (by weight) inorganic filler (TiO₂). It was observed that Package 5a (horizontally cooked, no cooking spray) showed minimal adherence (“1.5”). Package 5b (vertically cooked, no cooking spray) showed a small amount of adherence (“2”). Package 5c (horizontally cooked, with the addition of cooking spray) showed minimal adherence (“1.5”). Package 5d (vertically cooked, with the addition of cooking spray) showed minimal adherence (“1.5”).

Packages 6a-6d were constructed from monolayer films containing 22.5% (by weight) inorganic filler (TiO₂). It was observed that Package 6a (horizontally, no cooking spray) showed significant adherence (“4.5”). Packages 6b (vertically cooked, no cooking spray) showed significant adherence (“4.5”). Package 6c (horizontally cooked, no cooking spray) showed a small amount of adherence (“2”). Package 6d (vertically cooked with the addition of cooking spray) showed minimal adherence (“1.5”).

### CONCLUSIONS

The packages prepared from films containing the inorganic material performed better (i.e., there was less adhesion of the protein to the films after cooking) than those packages prepared from films lacking inorganic fillers. In addition, packages that were coated with cooking spray exhibited less adherence compared to packages lacking the cooking spray.

What is claimed is:

1. A retortable film comprising a sealant layer comprising between about 10% and 50% of at least one inorganic material, based on the total weight of the layer, wherein the amount of inorganic material is effective to substantially preclude adherence of the sealant layer to a protein-containing product in contact with said layer in conditions of from about 200° F. to about 450° F. for about 10 minutes to about 180 minutes.

2. The retortable film of claim 1, wherein said at least one inorganic material is selected from the group comprising: calcium carbonate, calcium sulfate, silicate, silica, titanium dioxide, potassium iodide, calcium phosphate, microspheres, and combinations thereof.

3. The retortable film of claim 1, further comprising between about 50% and 90% nylon, based on the total weight of the layer.

4. The retortable film of claim 3, wherein said nylon is selected from the group comprising: nylon 6, nylon 66, nylon 69, nylon 610, nylon 612, nylon 4/6 nylon 6/66, nylon 6/69, nylon 6/610, nylon 66/610, nylon 6/12, nylon 6/12/66, nylon 6/66/610, nylon 6/12/66, nylon 69/66/61, nylon 10/10, nylon 11, nylon 12, nylon 6/12, MXD6, MXD6/MXDI, 66/MXD10, PA-6I/6T, PA-6I, PA-MXDI, PA-6/MXDT/I, PA-6,6/6I, amorphous polyamide, and combinations thereof.

5. The retortable film of claim 1, wherein said protein-containing product comprises at least 40 weight % proteinaceous food.

6. An article comprising:
a. a package defining an inside; and
b. a protein-containing product positioned inside the package;
wherein said package comprises a retortable film comprising a sealant layer comprising between about 10% and about 50% of at least one inorganic material, based on the total weight of the layer; and
wherein the amount of inorganic material is effective to substantially preclude adherence of the sealant layer to said protein-containing product in contact with said layer in conditions of from about 200° F. to about 450° F. for about 10 minutes to about 180 minutes.

7. The article of claim 6, wherein said at least one inorganic material is selected from the group comprising: calcium carbonate, calcium sulfate, silicate, silica, titanium dioxide, potassium iodide, calcium phosphate, microspheres, and combinations thereof.

8. The article of claim 6, further comprising between about 50% and 90% nylon, based on the total weight of the layer.

9. The article of claim 8, wherein said nylon is selected from the group comprising: nylon 6, nylon 66, nylon 69, nylon 610, nylon 612, nylon 4/6 nylon 6/66, nylon 6/69, nylon 6/610, nylon 66/610, nylon 6/12, nylon 6/12/66, nylon 6/66/610, nylon 6/12/66, nylon 69/66/61, nylon 10/10, nylon 11, nylon 12, nylon 6/12, MXD6, MXD6/MXDI, 66/MXD10, PA-6I/6T, PA-6I, PA-MXDI, PA-6/MXDT/I, PA-6,6/6I, amorphous polyamide, and combinations thereof.

10. The article of claim 6, wherein said protein-containing product comprises at least 40 weight % proteinaceous food.

11. A method of preparing a retortable article, said method comprising:
a. preparing a protein-containing product;
b. packaging said protein-containing product in a retortable package constructed from a film comprising a sealant layer comprising between about 10% and 50% of at least one inorganic material, based on the total weight of the layer; and
c. sealing the package closed so that an article is made, with the protein-containing product being surrounded by said film; and
d. retorting the food product by subjecting the article to a temperature of from about 200° F. to about 450° F. for a period of from about 10 minutes to about 180 minutes.

12. The method of claim 11, wherein said at least one inorganic material is selected from the group comprising: calcium carbonate, calcium sulfate, silicate, silica, titanium dioxide, potassium iodide, calcium phosphate, microspheres, and combinations thereof.

13. The method of claim 11, further comprising between about 50% and 90% nylon, based on the total weight of the layer.

14. The method of claim 13, wherein said nylon is selected from the group comprising: nylon 6, nylon 66, nylon 69, nylon 610, nylon 612, nylon 4/6 nylon 6/66, nylon 6/69, nylon 6/610, nylon 66/610, nylon 6/12, nylon 6/12/66, nylon 6/66/610, nylon 6/12/66, nylon 69/66/61, nylon 10/10, nylon 11, nylon 12, nylon 6/12, MXD6, MXD6/MXDI, 66/MXD10, PA-6I/6T, PA-6I, PA-MXDI, PA-6/MXDT/I, PA-6,6/6I, amorphous polyamide, and combinations thereof.

15. The method of claim 11, wherein said protein-containing product comprises at least 40 weight % proteinaceous food.
